(19) United States
(12) Patent Application Publication
(10) Pub. No.: US 2026/0299784 A1
(43) Pub. Date: Oct. 1, 2026

(54) STORAGE SYSTEM AND STORAGE CONTROL METHOD

(71) Applicant: Hitachi Vantara, Ltd., Kanagawa-ken (JP)

(72) Inventors: Tetsuaki NUKATA, Tokyo (JP); Taisuke ONO, Tokyo (JP); Shintaro ITO, Tokyo (JP); Yoshinori OHIRA, Tokyo (JP)

(21) Appl. No.: 19/324,522

(22) Filed: Sep. 10, 2025

(30) Foreign Application Priority Data
Mar. 31, 2025 (JP) 2025-059214

(51) Int. Cl. G06F 3/06

(52) U.S. Cl. CPC G06F 3/0611; G06F 3/0659; G06F 3/067

(57) ABSTRACT

When a data write request is received from a request source, a storage controller stores write request data in a first volatile storage device, stores a log corresponding to the stored data in a non-volatile storage device, sends a completion response to the request source after storing the log, moves the data stored in the first volatile storage device to a second volatile storage device when no cache hit occurs for the data stored in the first volatile storage device over a first period from a first time when the data is stored in the first volatile storage device, and destages the data stored in the second volatile storage device to the non-volatile storage device when no cache hit occurs for the data stored in the second volatile storage device over a second period from a second time when the data is stored in the second volatile storage device.

### CROSS REFERENCE TO RELATED APPLICATION

This application relates to and claims the benefit of priority from Japanese Patent Application number 2025-059214, filed on Mar. 31, 2025 the entire disclosure of which is incorporated herein by reference.

### BACKGROUND OF THE INVENTION

### 1. Field of the Invention

The present invention relates to a storage system and a storage control method, and is suitably applied to, for example, a storage system related to a technique using a cache when executing read and write processing of data with a host apparatus.

### 2. Description of Related Art

In recent years, a storage system is expected to have both high performance and high reliability. As such a storage system, there is a storage system disclosed in PTL 1. The storage system includes a volatile memory, a non-volatile storage device, and a storage controller. The storage controller executes data read and write processing using a storage function. Data write processing is executed according to the following procedure. First, upon receiving a write request from a request source, the storage controller temporarily stores corresponding data in the volatile memory. Next, the storage controller stores a log related to the data in the non-volatile storage device. When log storage is completed, the storage controller returns a completion response to the request source. Finally, the storage controller processes the data stored in the memory by the storage function and destages the data to a storage device. Accordingly, permanent storage of the data is completed.

In order to improve performance and reliability, the storage controller stores control information and cache data in the volatile memory, stores logs for the stored control information and the stored cache data in the non-volatile storage device, and then sends the completion response to the request source. Thereafter, the storage controller destages the cache data stored in the volatile memory to the non-volatile storage device.

### CITATION LIST

### Patent Literature

PTL 1: JP2023-152247A

### SUMMARY OF THE INVENTION

However, in such a configuration, an amount of data input from and output to the non-volatile storage device increases when the data read and write processing is executed, which may become a performance bottleneck.

The invention has been invented in view of the above point and proposes a storage system that can reduce an amount of data input from and output to a non-volatile storage device.

In order to solve this problem, the invention includes: a first volatile storage device configured to temporarily store data and store data to be transmitted to and received from a request source of an I/O request; a second volatile storage device configured to temporarily store data; a non-volatile storage device configured to permanently store data; and a storage controller configured to control input and output processing of data from and to the first volatile storage device, the second volatile storage device, and the non-volatile storage device, in which, based on a status of access to data stored in the first volatile storage device, the second volatile storage device, and the non-volatile storage device, the storage controller moves the data among the first volatile storage device, the second volatile storage device, and the non-volatile storage device.

The invention also provides a storage control method for a storage system, in which the storage system includes a first volatile storage device configured to temporarily store data and store data to be transmitted to and received from a request source of an I/O request, a second volatile storage device configured to temporarily store data, a non-volatile storage device configured to permanently store data, and a storage controller configured to control input and output processing of data from and to the first volatile storage device, the second volatile storage device, and the non-volatile storage device, and based on a status of access to data stored in the first volatile storage device, the second volatile storage device, and the non-volatile storage device, the storage controller moves the data among the first volatile storage device, the second volatile storage device, and the non-volatile storage device.

According to the invention, it is possible to reduce an amount of data input from and output to a non-volatile storage device.

### BRIEF DESCRIPTION OF THE DRAWINGS

FIG. 1 is a system configuration diagram showing a configuration example of a storage system according to the embodiment.

FIG. 2 shows an example of a physical configuration of a storage node shown in FIG. 1.

FIG. 3 shows an example of a logical configuration of the storage node.

FIG. 4 is a conceptual diagram showing an overview of a storage system and a storage control method according to the embodiment.

FIG. 5 shows a configuration example of a memory storage area.

FIG. 6 shows an example of a configuration diagram of a second volatile storage device.

FIG. 7 shows an example of a configuration diagram of a non-volatile storage device.

FIG. 8 is a block diagram showing an example of a storage controller software module structure.

FIG. 9 shows an example of a cache directory.

FIG. 10 shows a configuration example of a log header.

FIG. 11 is a flowchart showing an example of a procedure of read processing.

FIG. 12 is a flowchart showing an example of a procedure of write processing.

FIG. 13 is a flowchart showing an example of a processing procedure for moving data from a memory that is an example of a first volatile storage device to the second volatile storage device.

FIG. 14 is a flowchart showing an example of a procedure of asynchronous destaging processing.

FIG. 15 is a flowchart showing an example of a procedure of control information update processing.

FIG. 16 is a flowchart showing an example of a procedure of cache data update processing.

FIG. 17 is a flowchart of log creation processing.

FIG. 18 is a flowchart of control information determination processing.

FIG. 19 is a flowchart showing an example of a procedure of log evacuation processing.

FIG. 20 is a flowchart showing an example of a procedure of log recovery processing.

### DESCRIPTION OF EMBODIMENTS

Hereinafter, the embodiment of the invention will be described in detail with reference to the drawings. The following embodiment relates to a storage system including a plurality of storage nodes in each of which one or more software defined storages (SDS) are implemented.

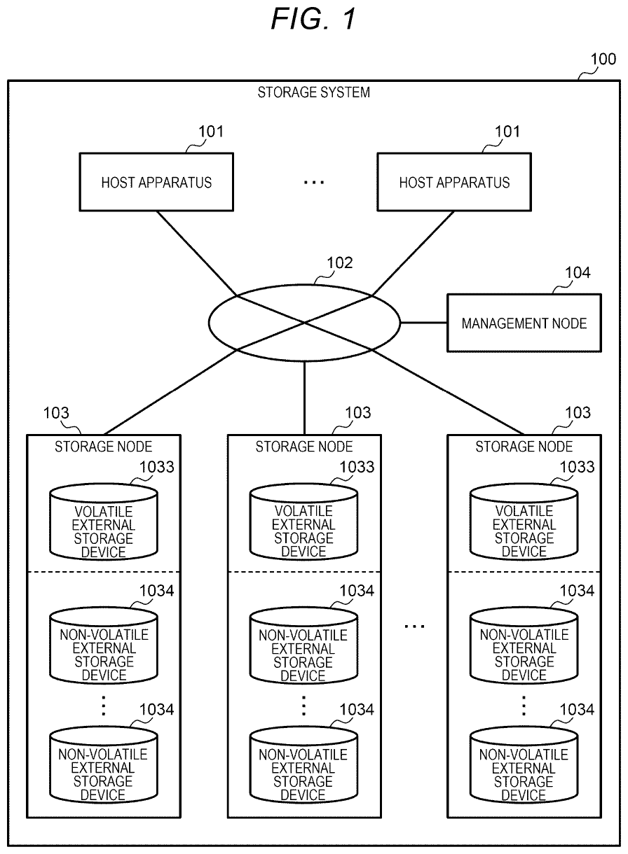

FIG. 1 is a system configuration diagram showing a configuration example of a storage system 100 according to the embodiment. The storage system 100 includes one or more storage nodes 103, and further includes one or more host apparatuses 101 and a management node 104. The host apparatuses 101, the storage nodes 103, and the management node 104 are connected via a network 102.

Each host apparatus 101 is a general-purpose computer used by a user. For example, the host apparatus 101 may be a physical computer or may be a virtual computer executed on the physical computer. The host apparatus 101 transmits, for example, a read request or a write request to each storage node 103 in response to a request from a user operation or an application program. Hereinafter, “the read request or the write request” is also referred to as an “I/O request”.

The network 102 may be, for example, a storage area network (SAN) or a local area network (LAN). A connection standard of the network 102 is, for example, Fibre Channel (FC) or Ethernet (registered trademark).

The storage node 103 is a computer equipped with an external storage device such as a solid state drive (SSD) or a hard disk drive (HDD). The storage node 103 may also be, for example, a general-purpose server. The storage node 103 has a storage area for reading and writing data. The storage node 103 provides a non-volatile storage area as an example of a storage area for the host apparatus 101. The storage area may include a volatile storage area.

The management node 104 is a computer used by an administrator to manage the entire storage system 100. The management node 104 manages two or more storage nodes as a “cluster”. There may be one or more clusters in the storage system 100.

A form of the storage system 100 may be on-premises, cloud, or a hybrid of both. The network 102 may be, for example, a virtual network in the cloud. The storage node 103 may be, for example, a virtual server in the cloud.

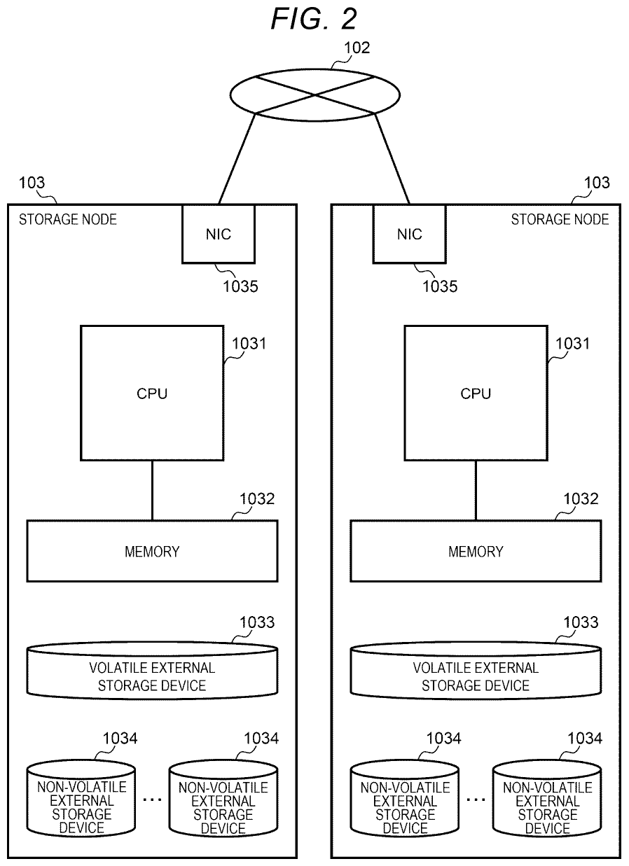

FIG. 2 shows an example of a physical configuration of the storage node 103 of the storage system 100 shown in FIG. 1. In the shown example, the host apparatus 101 is omitted for simplicity of the drawing. The storage node 103 includes a central processing unit (CPU) 1031, a memory 1032 as an example of a first volatile storage device, one or more second volatile storage devices 1033, one or more non-volatile storage devices 1034, and a network interface card (NIC) 1035.

The storage node 103 of the storage system 100 includes the memory 1032 that can temporarily store data related to the I/O request from the host apparatus 101 that is a request source and stores data to be transmitted to and received from the request source of the I/O request, each second volatile storage device 1033 that can temporarily store data, each non-volatile storage device 1034 that can permanently store data, and a storage controller that controls data input and output processing relative to the memory 1032, the second volatile storage device 1033, and the non-volatile storage device 1034. The storage controller moves data among the memory 1032, the second volatile storage device 1033, and the non-volatile storage device 1034 based on a status of access to the data stored in the memory 1032, the second volatile storage device 1033, and the non-volatile storage device 1034. In the embodiment, for example, the memory 1032 is byte-accessible, and the second volatile storage device 1033 and the non-volatile storage device 1034 are not byte-accessible.

Upon receiving a write request of data from the host apparatus 101 that is an example of the request source, the storage controller stores the data corresponding to the write request in the memory 1032 and stores a log corresponding to the data stored in the memory 1032 in the non-volatile storage device 1034. After storing the log in the non-volatile storage device 1034, the storage controller sends a completion response to the host apparatus 101 and moves the data stored in the memory 1032 to the second volatile storage device 1033 to store the data therein when no cache hit occurs for the data stored in the memory 1032 over a first period from a first time when the data is stored in the memory 1032. The storage controller destages the data stored in the second volatile storage device 1033 to the non-volatile storage device 1034 when no cache hit occurs for the data stored in the second volatile storage device 1033 over a second period from a second time when the data is stored in the second volatile storage device 1033.

The storage controller manages clean data where the data stored in the memory 1032 is identical to the data stored in the non-volatile storage device 1034 and dirty data where the data stored in the memory 1032 is not destaged to the non-volatile storage device 1034. The storage controller moves the dirty data in the data stored in the memory 1032 to the second volatile storage device 1033 to store the dirty data therein. For example, the storage controller may not move the clean data to the second volatile storage device 1033 and may not store the clean data therein. In the embodiment, the memory 1032 can input and output data in a data unit related to the I/O request. The second volatile storage device 1033 and the non-volatile storage device 1034 input and output data in a unit larger than the data unit related to the I/O request.

The CPU 1031 is a processor device that controls an operation of the storage node 103. The memory 1032 is a semiconductor memory that temporarily stores an application program and data. The memory 1032 is, for example, a static random access memory (SRAM) or a dynamic random access memory (DRAM). The CPU 1031 controls the operation of the storage node 103 by executing the application program retained by the memory 1032.

The second volatile storage device 1033 is, for example, a volatile storage device that temporarily retains data. The second volatile storage device 1033 is controlled, for example, such that the stored data is erased at the same time when a virtual machine in the cloud is shut down. The second volatile storage device 1033 may be, for example, an external storage device (instance store) in the cloud. Therefore, the external storage device physically used here may be, for example, a non-volatile storage device such as a non-volatile memory express (NVMe) drive. In the embodiment, the second volatile storage device 1033 has higher I/O performance than the non-volatile storage device 1034, is accessed faster than the non-volatile storage device 1034, and can input and output more data than the non-volatile storage device 1034.

The non-volatile storage device 1034 provides a physical storage area for reading or writing the data in response to the I/O request from the host apparatus 101 that is the request source. The non-volatile storage device 1034 is, for example, a hard disk drive (HDD), a solid state drive (SSD), or an NVMe drive. Alternatively, the non-volatile storage device 1034 may be a shared storage device attached via a network.

The NIC 1035 is an interface for the storage node 103 to communicate with the host apparatus 101, another storage node 103, or the management node 104 via the network 102. The NIC 1034 may be, for example, an FC card in addition to the NIC. The NIC 1034 performs protocol control in communication with the host apparatus 101, another storage node 103, or the management node 104.

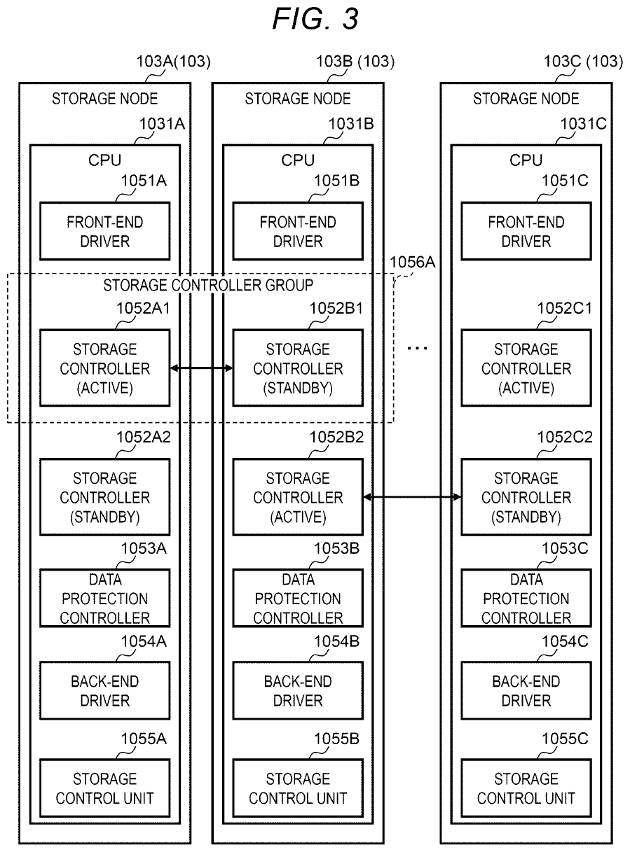

FIG. 3 shows an example of a logical configuration of the storage node 103. The storage node 103 includes front-end drivers 1051A, 1051B, and 1051C, one or more storage controllers 1052A1,1052A2, 1052B1, 1052B2, 1052C1, and 1052C2, data protection controllers 1053A, 1053B, and 1053C, and back-end drivers 1054A, 1054B, and 1054C. In the embodiment, the storage controllers 1052A1 and 1052A2 may be collectively referred to as a storage controller 1052A, the storage controllers 1052B1 and 1052B2 may be collectively referred to as a storage controller 1052B, and the storage controllers 1052C1 and 1052C2 may be collectively referred to as a storage controller 1052C.

The front-end drivers 1051A, 1051B, and 1051C are software having a function of controlling the NIC 1034 and providing the CPU 1031 with an abstracted interface for the storage controllers 1052A, 1052B, and 1052C when communicating with the host apparatus 101, another storage node 103, or the management node 104.

The back-end drivers 1054A, 1054B, and 1054C are software having a function of controlling each second volatile storage device 1033 in their own storage node 103 and providing the CPU 1031 with an abstracted interface when communicating with each second volatile storage device 1033.

The storage controllers 1052A, 1052B, and 1052C are, for example, software that functions as a controller of software defined storage (SDS). The storage controllers 1052A, 1052B, and 1052C receive the I/O request from the host apparatus 101 and issue an I/O command corresponding to the I/O request to the data protection controllers 1053A, 1053B, and 1053C. The storage controllers 1052A, 1052B, and 1052C each have a logical volume configuration function. The logical volume configuration function associates a logical chunk configured by the data protection controllers 1053A, 1053B, and 1053C with a logical volume provided to a host. The association may be, for example, a straight mapping method (in which the logical chunk and the logical volume are associated 1:1 and an address of the logical chunk and an address of the logical volume are the same) or a virtual volume function (Thin Provisioning) method. The Thin Provisioning method has a function of, for example, dividing the logical chunk and the logical volume into small-sized regions (pages) and associating the addresses of the logical chunk and the logical volume in units of pages.

In the embodiment, the storage system 100 includes a plurality of storage nodes 103, and each storage node 103 includes the memory 1032, the second volatile storage device 1033, the non-volatile storage device 1034, and the storage controller. The storage controller in the storage node 103 forms a redundant configuration together with one or more storage controllers on other storage nodes 103.

Among the storage controllers 1052A, 1052B, and 1052C forming the redundant configuration, for example, the storage controller 1052A is set to a state in which the I/O request from the host apparatus 101 that is the request source can be received (active state to be described later), and the other storage controller 1052B is set to a standby state for taking over processing of the controller 1052A in the active state to be described later (standby state to be described later).

In the embodiment, a storage controller group 1056 is managed, in which the storage controllers 1052A, 1052B, and 1052C on a certain storage node 103 form a redundant configuration together with one or more storage controllers 1052A, 1052B, and 1052C on another storage node 103. In the storage controller group 1056, one of the storage controllers 1052A, 1052B, and 1052C is set to the state in which the I/O request from the host apparatus 101 can be received (an active-system state referred to as the active state).

In a storage control unit 1055, the storage controller 1052A, 1052B, or 1052C that is not in the active state is set to the state in which the I/O request from the host apparatus 101 is not received (a standby-system state referred to as the standby state). In FIG. 3, for example, the storage controller 1052A1 in a storage node 103A is set to the active state and the storage controller 1052B1 in a storage node 103B is set to the standby state, thereby forming a storage controller group 1056A.

In the storage controller group 1056, when a failure occurs in the storage node 103 where the storage controllers 1052A, 1052B, and 1052C of the storage node 103 set to the active state are disposed, states of the storage controllers 1052A, 1052B, and 1052C of another storage node 103 set to the standby state so far are switched to the active state. Accordingly, when the storage controllers 1052A, 1052B, and 1052C of the storage node 103 set to the active state cannot operate, the storage controllers 1052A, 1052B, and 1052C of the other storage node 103 set to the standby state can take over I/O processing executed by the storage controllers 1052A, 1052B, and 1052C.

The data protection controllers 1053A, 1053B, and 1053C are software having a function of allocating a physical storage area provided by the second volatile storage device 1033 in the their own storage node 103 or the second volatile storage device 1033 of another storage node 103 to each storage controller group 1056A, and reading or writing designated data to the corresponding second volatile storage device 1033 according to the I/O command provided by the storage controllers 1052A, 1052B, and 1052C.

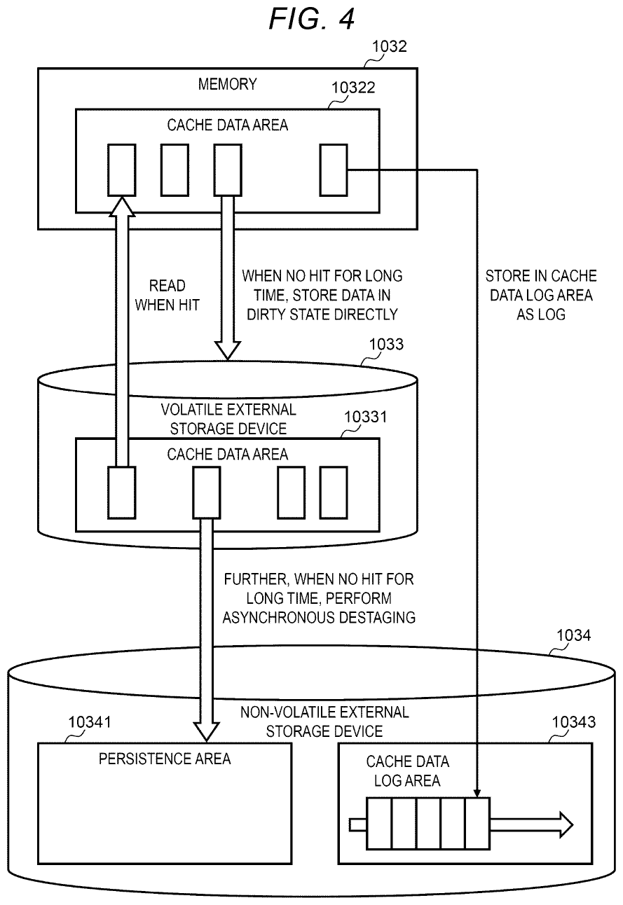

FIG. 4 is a conceptual diagram showing an overview of the storage system and a storage control method thereof according to the embodiment. First, an overview of the storage control method according to the embodiment will be described. The storage control method is a storage control method for the storage system 100 including the memory 1032, which is an example of the first volatile storage device that can temporarily store data related to the I/O request from the host apparatus 101 as an example of the request source and stores data to be transmitted to and received from the request source of the I/O request, the second volatile storage device 1033, which can temporarily store data, the non-volatile storage device 1034, which can permanently store data, and the storage controller that controls input and output processing of data from and to the memory 1032, the second volatile storage device 1033, and the non-volatile storage device 1034. The storage controller moves the data among the memory 1032, the second volatile storage device 1033, and the non-volatile storage device 1034 based on a status of access to the data stored in the memory 1032, the second volatile storage device 1033, and the non-volatile storage device 1034. For example, upon receiving a write request of data from the host apparatus 101, the storage controller stores the data corresponding to the write request in the memory 1032, stores a log corresponding to the data stored in the memory 1032 in the non-volatile storage device 1034, and sends a completion response to the host apparatus 101 after storing the log in the non-volatile storage device 1034. For example, the storage controller moves the data stored in the memory 1032 to the second volatile storage device 1033 to store the data therein when no cache hit occurs for the data stored in the memory 1032 over the first period from the first time when the data is stored in the memory 1032. Further, for example, the storage controller destages the data stored in the second volatile storage device 1033 to the non-volatile storage device 1034 when no cache hit occurs for the data stored in the second volatile storage device 1033 over the second period from the second time when the data is stored in the second volatile storage device 1033. In the embodiment, as described above, for example, the memory 1032 is byte-accessible, and the second volatile storage device 1033 and the non-volatile storage device 1034 are not byte-accessible.

First. The storage controllers 1052A, 1052B, and 1052C update cache data for processing associated with the I/O request from the host apparatus 101 and various other types of processing. The memory 1032 has a cache data area 10322. The second volatile storage device 1033 has a cache data area 10331. The non-volatile storage device 1034 has a persistence area 10341 that permanently retains data and a cache data log area 10343 that retains a log.

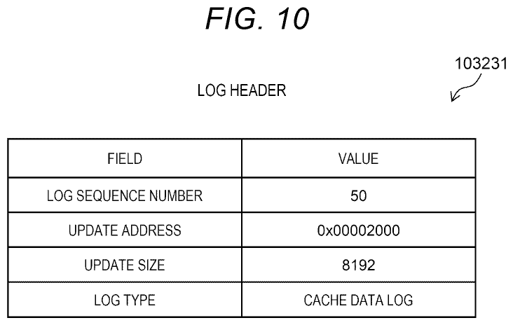

At this time, the storage controllers 1052A, 1052B, and 1052C update cache data in the cache data area 10322 of the memory 1032, create a log, and store the log in the cache data log area 10343 in the non-volatile storage device 1034 to make the log non-volatile. The log includes the updated cache data itself and a log header, and is information indicating how the cache data in the memory 1032 is updated. The log header includes an update address, an update size, and a log type for each log sequence number (see FIG. 10 to be described later).

The cache data in the cache data area 10322 of the memory 1032 has a state for identifying whether the data is also updated in the persistence area 10341 in the non-volatile storage device 1034. When the data is also updated in the persistence area 10341, the data is in a clean state, and when the data is not updated, the data is in a dirty state.

The storage controllers 1052A, 1052B, and 1052C store the cache data in the cache data area 10322 of the memory 1032 into the cache data area 10331 of the second volatile storage device 1033 directly in the dirty state. The storage controllers 1052A, 1052B, and 1052C read the cache data in the cache data area 10331 of the second volatile storage device 1033 into the cache data area 10322 of the memory 1032.

The storage controllers 1052A, 1052B, and 1052C perform asynchronous destaging for the cache data in the dirty state in the cache data area 10331 of the second volatile storage device 1033. The asynchronous destaging is an operation of writing data in the cache data area 10331 to the persistence area 10341 asynchronously with the I/O request.

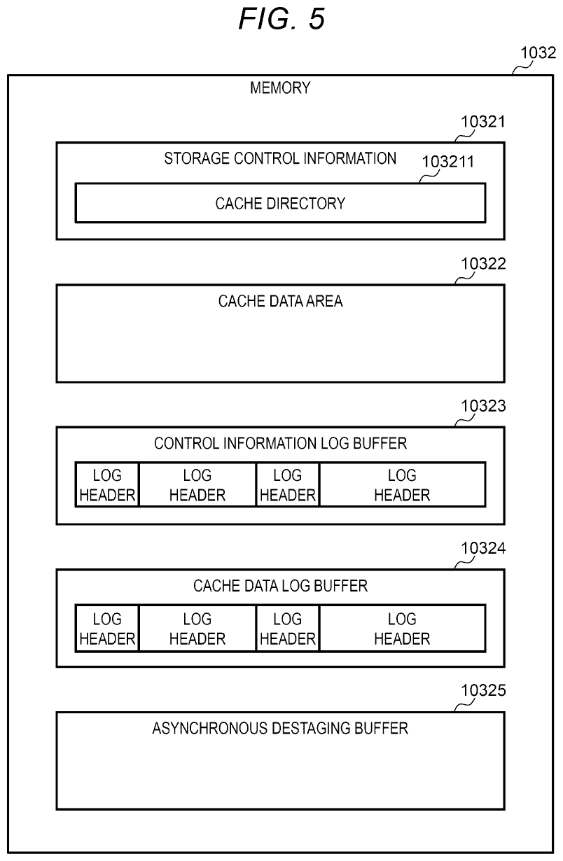

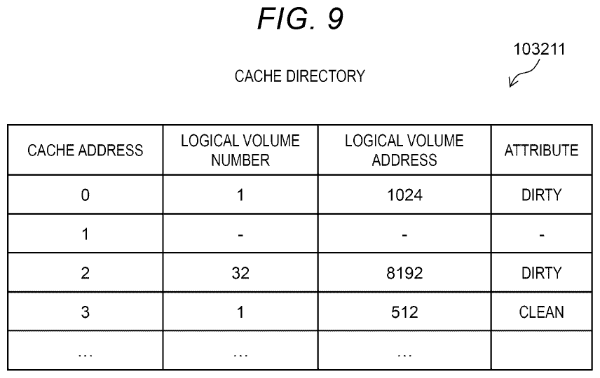

FIG. 5 shows a configuration example of a storage area of the memory 1032. The memory 1032 has storage control information 10321, the cache data area 10322, a control information log buffer 10323, a cache data log buffer 10324, and an asynchronous destaging buffer 10325. The storage control information 10321 includes a cache directory 103211. The cache directory will be described with reference to FIG. 9. The control information log buffer 10323 temporarily stores a control information log, and the cache data log buffer 10324 temporarily stores a cache data log.

The control information log buffer 10323 has, for example, four types of log headers. The cache data log buffer 10324 has, for example, four types of log headers.

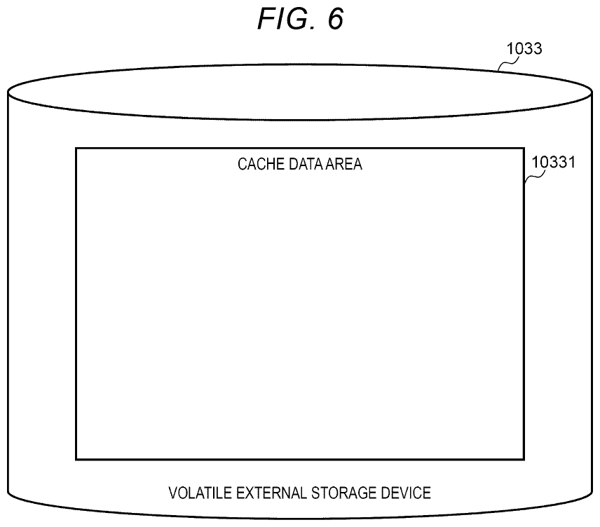

FIG. 6 shows an example of a configuration diagram of the second volatile storage device 1033. The second volatile storage device 1033 has the cache data area 10331 in addition to the cache data area 10322 of the memory 1032. The cache data area 10331 will be described later.

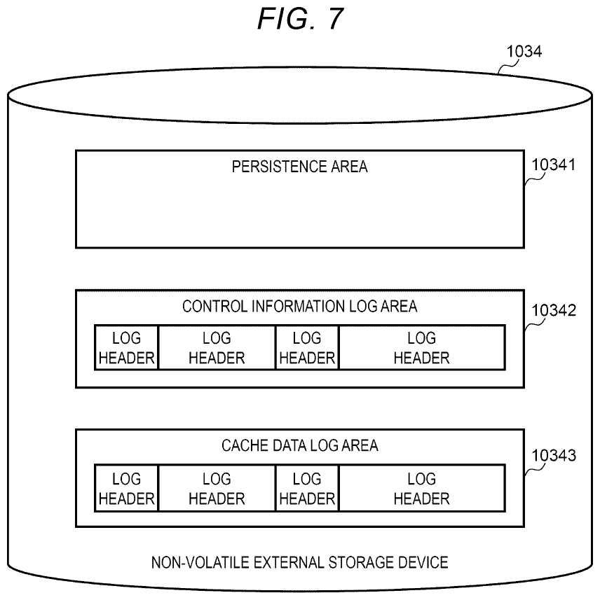

FIG. 7 shows an example of a configuration diagram of the non-volatile storage device 1034. The non-volatile storage device 1034 has the persistence area 10341, a control information log area 10342, and the cache data log area 10343. The persistence area 10341 is an area for storing user data managed by the data protection controllers 1053A, 1053B, and 1053C. The control information log area 10342 and a cache data log area 10343 are destination areas for log evacuation in log evacuation processing to be described later.

The control information log area 10342 has, for example, four types of log headers. The cache data log area 10343 has, for example, four types of log headers.

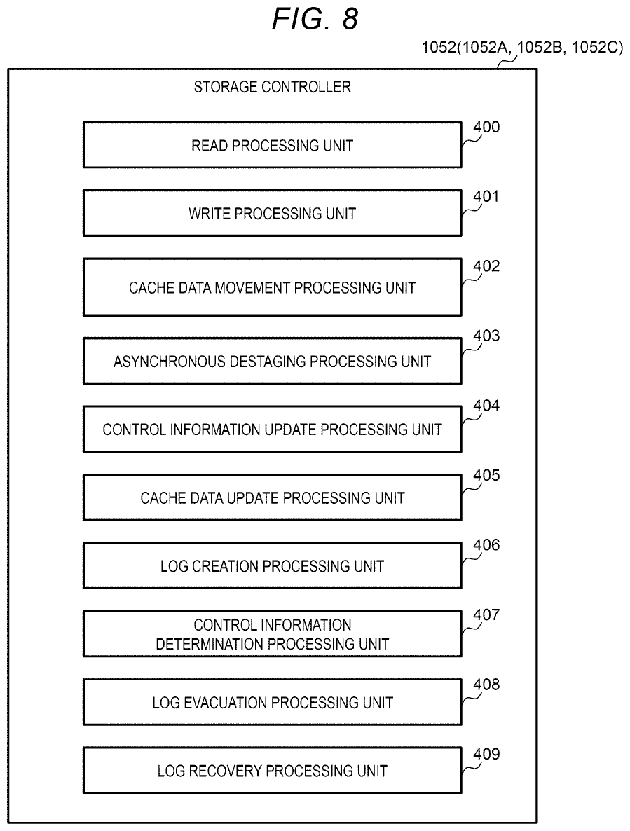

FIG. 8 is a block diagram showing a configuration example of a software module of the storage controllers 1052A, 1052B, and 1052C. The storage controllers 1052A, 1052B, and 1052C execute a read processing unit 400, a write processing unit 401, a cache data movement processing unit 402, an asynchronous destaging processing unit 403, a control information update processing unit 404, a cache data update processing unit 405, a log creation processing unit 406, a control information determination processing unit 407, a log evacuation processing unit 408, and a log recovery processing unit 409. The cache data movement processing unit 402 controls movement of the cache data from the memory 1032 to the second volatile storage device 1033. Details of the read processing unit 400 and the like will be described later.

FIG. 9 shows an example of the cache directory 103211. The cache directory 103211 is management information on a cache segment that is an area obtained by subdividing the cache data area 10322 and the cache data area 10331. The cache directory 103211 has an entry corresponding to each cache segment.

Each entry includes a cache address, a logical volume number, a logical volume address, and an attribute. The cache address indicates an address, in the memory 1032, of the cache segment to which each entry corresponds. The logical volume number and the logical volume address indicate which logical volume address in which logical volume data stored in the cache segment belongs to. When no data is stored in the cache segment, “−” indicating “no value” is stored. On the other hand, when data is stored in the cache segment, a value of “dirty” or “clean” is stored in the attribute field.

FIG. 10 shows a configuration example of a log header 103231. The log header 103231 has the following fields and values corresponding to the respective fields. The log header 103231 is, for example, a table in each log stored in the control information log buffer 10323 and the cache data log buffer 10324 in the above-described memory 1032, a cache data log header management list, and the control information log area 10342 and the cache data log area 10343 in the above-described non-volatile storage device 1034. Each log header 103231 includes, as fields, for example, a log sequence number, an update address, an update size, and a log type.

The log sequence number field stores a log sequence number uniquely assigned to each log. The update address field stores an address of the cache data area 10322 to be updated by each log. The update size field stores a size of the cache data to be updated by each log.

The log type field stores a value (log type) for identifying what type of log is created at the time of log creation. The log type includes, for example, a cache data log associated with the write processing unit 401 and a destaging log associated with the asynchronous destaging processing unit 403. The log type field may store a character string such as “cache data log” or “destaging log”, or may store a numerical value such as “1” or “2”.

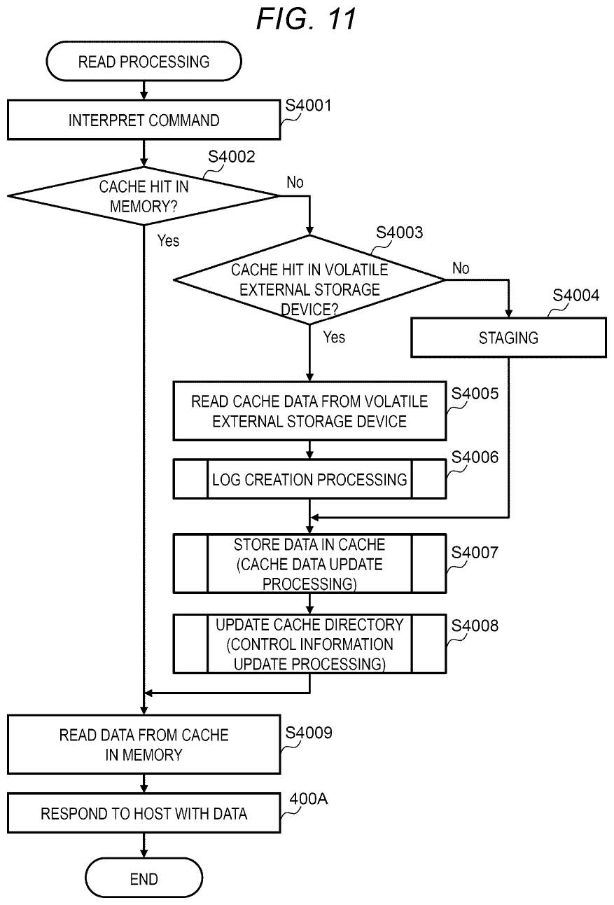

FIG. 11 is a flowchart showing an example of a procedure of read processing. The read processing is called when a read I/O request is received from the host apparatus 101. The read processing is executed by the read processing unit 400 of each of the storage controllers 1052A, 1052B, and 1052C. In the shown example, when data related to the read request is absent in the memory 1032 and is present in the second volatile storage device 1033, the storage controllers 1052A, 1052B, and 1052C store the data in the second volatile storage device 1033 into the memory 1032 and respond to the host apparatus 101 that is the request source of the read request with the data stored in the memory 1032.

First, the read processing unit 400 receives the read I/O request transmitted by the host apparatus 101 via the front-end drivers 1051A, 1051B, and 1051C, and interprets the read I/O request to obtain a logical volume number and a logical volume address to be read (step S4001).

Subsequently, the read processing unit 400 determines whether cache data corresponding to the logical volume number and the logical volume address is present in the cache data area 10322 of the memory 1032 (cache hit) (step S4002). When a cache hit occurs (step S4002; Yes), the read processing unit 400 reads the data from the cache data area 10322 of the memory 1032 (step S4008) and responds to the host with the data (step S4009).

When a cache miss occurs in the cache data area 10322 of the memory 1032 (step S4002; No), the read processing unit 400 determines whether the cache data corresponding to the logical volume number and the logical volume address is present in the cache data area 10331 of the second volatile storage device 1033 (cache hit) (step S4003).

When a cache hit occurs (step S4003; Yes), the read processing unit 400 reads the data from the cache data area 10331 of the second volatile storage device 1033 (step S4005) and calls log creation processing when the read data is in a dirty state (step S4006). Thereafter, the read processing unit 400 stores the read data in the cache data area 10322 of the memory 1032 (step S4006).

At this time, the read processing unit 400 sets non-volatilization requirement to “YES” when the read data is in a dirty state, sets the non-volatilization requirement to “NO” when the read data is in a clean state, and calls cache data update processing to be described later. The read processing unit 400 updates the cache directory and calls control information update processing. At this time, similarly to the cache data update, the read processing unit 400 sets the non-volatilization requirement to “YES” when the read data is in a dirty state, and sets the non-volatilization requirement to “NO” when the read data is in a clean state.

Finally, the read processing unit 400 reads the data from the cache data area 10322 (step S4009) and responds to the host apparatus 101 with the data (step S400A), as in the case where the cache hit occurs in the cache data area 10322 of the memory 1032.

When a cache miss occurs in the cache data area 10331 of the second volatile storage device 1033 (step S4003; No), staging processing is called (step S4004). The staging processing is processing executed by the data protection controllers 1053A, 1053B, and 1053C. In the staging processing, the data corresponding to the logical volume number and the logical volume address is read from the persistence area 10341 in the non-volatile storage device 1034. The read data is stored in the cache data area 10322 in the memory 1032 (step S4007). At this time, the staging processing sets the non-volatilization requirement to “NO” and calls the cache data update processing unit 405 to be described later. As in the case of the cache hit, the data is read from the cache data area 10322 of the memory 1032 (step S4009), and the host apparatus 101 is responded to with the data (step S400A).

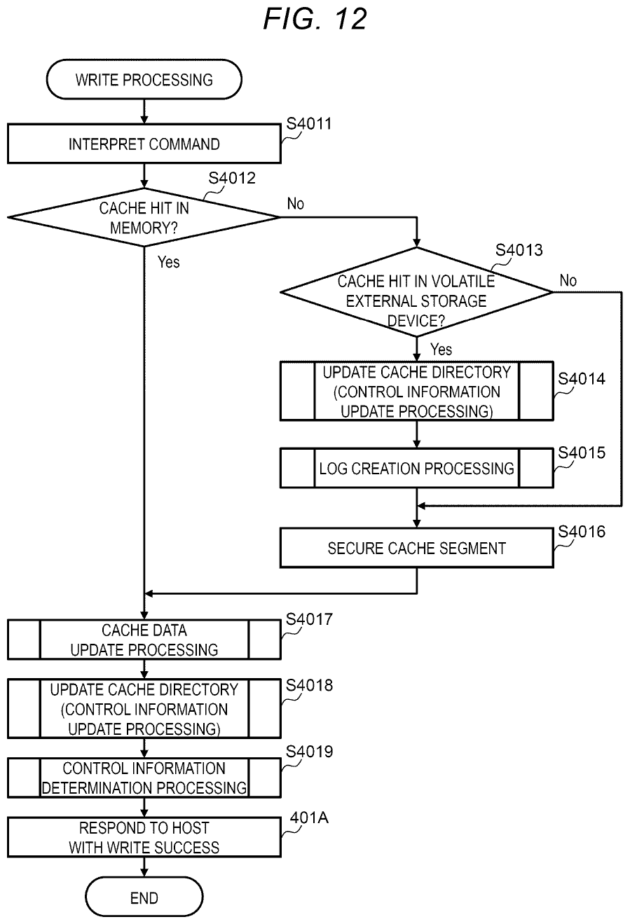

FIG. 12 is a flowchart showing an example of a procedure of write processing. The write processing is called when a write I/O request is received from the host apparatus 101 and is executed by the write processing unit 401 of each of the storage controllers 1052A, 1052B, and 1052C.

First, the write processing unit 401 receives the write I/O request transmitted by the host apparatus 101 via the front-end driver and interprets the write I/O request to obtain a logical volume number and a logical volume address to be written (step S4011).

Subsequently, the write processing unit 401 determines whether the cache data corresponding to the logical volume number and the logical volume address is present in the cache data area 10322 of the memory 1032 (cache hit) (step S4012). When a cache hit occurs (step S4012; Yes), the write processing unit 401 stores the data in the cache data area 10322 of the memory 1032 (step S4017). At this time, the write processing unit 401 sets the non-volatilization requirement to “YES” and calls the cache data update processing to be described later.

Subsequently, the write processing unit 401 updates the cache directory in the cache data update processing to be described later and calls the control information update processing (step S4018). At this time, the write processing unit 401 sets the non-volatilization requirement to “YES” and calls the processing, similarly to the cache data update. The write processing unit 401 calls control information determination processing to be described later (step S4019). Finally, the write processing unit 401 responds to the host apparatus 101 with a write success (step S401A).

When a cache miss occurs in the cache data area 10322 of the memory 1032 (step S4012; No), the write processing unit 401 determines whether the cache data is present in the cache data area 10331 of the second volatile storage device 1033 (cache hit) (step S4013). When a cache hit occurs (step S4013; Yes), the write processing unit 401 updates the cache directory and calls the control information update processing (step S4014). At this time, the write processing unit 401 sets the non-volatilization requirement to “YES” and calls the processing. The write processing unit 401 calls the log creation processing (step S4105). Subsequently, the write processing unit 401 secures a cache segment (4016), proceeds to step 4107, and then performs the same processing as in the case of the cache hit.

When a cache miss occurs in the cache data area 10331 of the second volatile storage device 1033 (step S4013; No), the write processing unit 401 executes step 4016 and then performs the same processing as in the case of the cache hit.

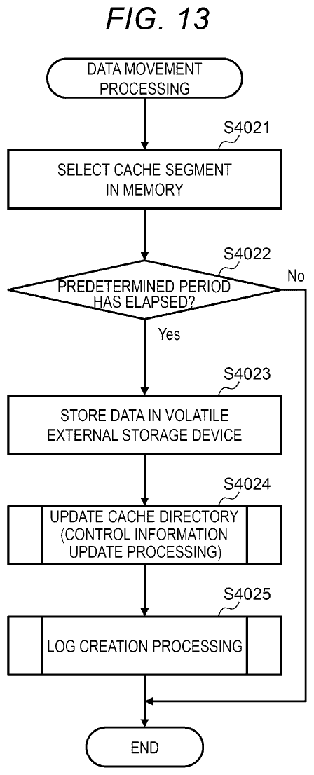

FIG. 13 is a flowchart showing an example of a processing procedure for moving data from the memory to the second volatile storage device 1033. First, the cache data movement processing unit 402 searches for a cache segment in the cache data area 10322 of the memory 1032 (step S4021) and determines whether a predetermined period has elapsed since the cache segment is stored in the cache data area 10322 of the memory 1032 (step S4022).

Meanwhile, when the predetermined period has not elapsed (step S4022; No), the cache data movement processing unit 402 ends the data movement processing. When the predetermined period has elapsed (step S4022; Yes), the cache data movement processing unit 402 stores the cache segment in the cache data area 10331 of the second volatile storage device 1033 (step S4023). Thereafter, the cache data movement processing unit 402 updates the cache directory and calls the control information update processing (step S4024). At this time, the non-volatilization requirement is set to “YES” and the processing is called. Next, the log creation processing is called (step S4025).

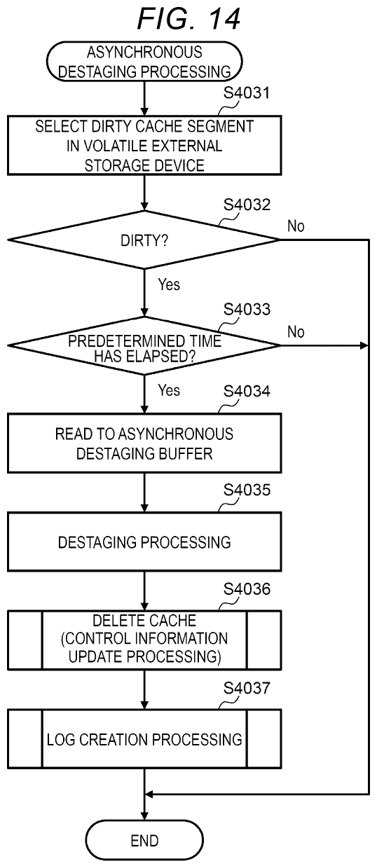

FIG. 14 is a flowchart showing an example of a procedure of asynchronous destaging processing. First, the asynchronous destaging processing unit 403 searches for a dirty cache segment in the cache data area 10331 of the second volatile storage device 1033 (step S4031) and ends the asynchronous destaging processing when there is no such cache segment (step S4032; No).

On the other hand, when there is a dirty cache segment (step S4032; Yes), the asynchronous destaging processing unit 403 determines whether a predetermined time has elapsed since the cache segment is stored in the cache data area 10331 of the second volatile storage device 1033 (step S4033).

When the predetermined time has not elapsed (step S4033; No), the asynchronous destaging processing unit 403 ends the asynchronous destaging processing. On the other hand, when the predetermined time has elapsed (step S4033; Yes), the asynchronous destaging processing unit 403 calls the cache segment to the asynchronous destaging buffer 10325 in the memory 1032 (step S4034) and executes destaging processing (step S4035). The destaging processing is processing executed by the storage controllers 1052A, 1052B, and 1052C, and the data protection controllers 1053A, 1053B, and 1053C. The asynchronous destaging processing unit 403 writes the data corresponding to the logical volume number and the logical volume address to the persistence area 10341 in the non-volatile storage device 1034. Thereafter, a corresponding entry is deleted from the cache directory, and the control information update processing is called (step S4036). At this time, the asynchronous destaging processing unit 403 sets the non-volatilization requirement to “YES” and calls the processing. Finally, the log creation processing is called (step S4037).

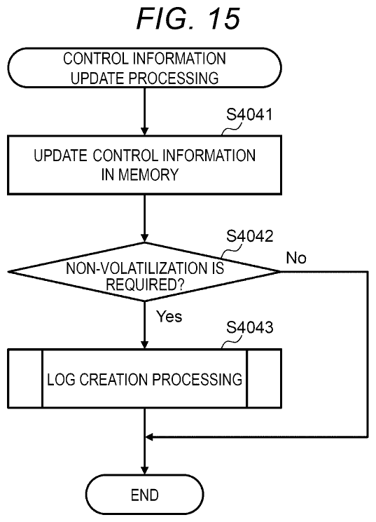

FIG. 15 is a flowchart showing an example of a procedure of the control information update processing. The control information update processing is called when control information in the memory 1032 is updated. When the control information update processing is called, a memory address for specifying the control information to be updated, a size, an update value, and information indicating the non-volatilization requirement are passed.

First, the control information update processing unit 404 updates the control information in the memory 1032 (step S4041). Subsequently, the control information update processing unit 404 refers to the passed non-volatilization requirement and determines whether non-volatilization is required (step S4042). Only when non-volatilization is required (step S4042; Yes), the log creation processing is called.

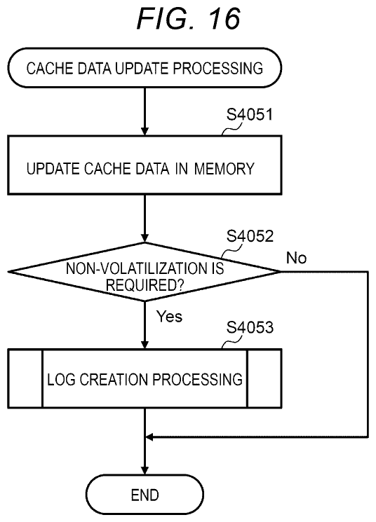

FIG. 16 is a flowchart showing an example of a procedure of the cache data update processing. The cache data update processing is called when updating the cache data in the memory 1032. When the cache data update processing is called, information indicating a memory address for specifying the cache data to be updated, a size, an update value, and non-volatilization requirement is passed to the cache data update processing unit 405.

First, the cache data update processing unit 405 updates the cache data in the memory 1032 (step S4051). Subsequently, the cache data update processing unit 405 refers to the passed non-volatilization requirement and determines whether non-volatilization is required (step S4052). Only when non-volatilization is required (step S4052; Yes), the log creation processing is called (step S4053).

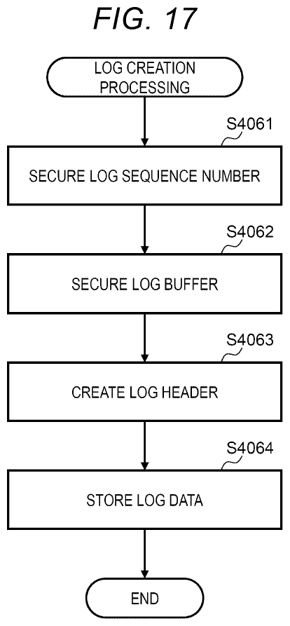

FIG. 17 is a flowchart of the log creation processing. First, the log creation processing unit 406 determines the log sequence number (step S4061). The log sequence number is a number assigned in an order of log creation such that exactly one log corresponds to one log sequence number. Subsequently, the log creation processing unit 406 secures an area for writing a log on a log buffer (step S4062). Subsequently, the log creation processing unit 406 creates the log header 103231 (step S4063).

The log creation processing unit 406 stores the above-described log sequence number in the sequence number field of the log header, stores the control information to be updated or the memory address for specifying the cache data in the update address field, and stores the update target size in the update size field.

In the log type field, “control information log” is stored when called from the control information update processing, and “cache data log” is stored when called from the cache data update processing. In the log type field, “cache data deletion log” is stored when called due to an operation of a volatile external storage device or when called from the asynchronous destaging processing.

The log creation processing unit 406 stores the log in the log buffer (step S4064). Specifically, the log creation processing unit 406 stores, in the log buffer, the log header at the head of the area secured in step 4042, and the control information or the cache data updated at a memory address obtained by adding the size of the log header to the secured area.

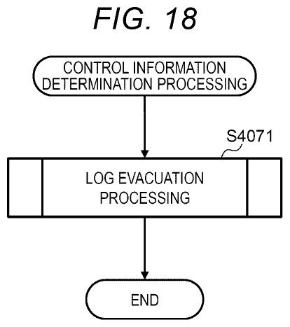

FIG. 18 is a flowchart of the control information determination processing. In the control information determination processing, the control information update processing unit 404 calls the log evacuation processing (step S4071). The log evacuation processing is executed by the log evacuation processing unit 408. The log evacuation processing will be described later.

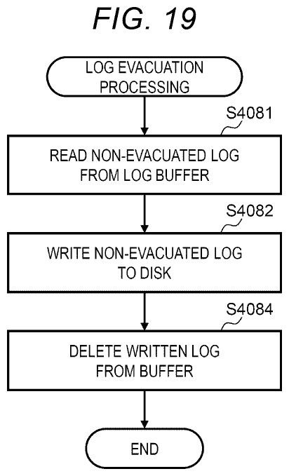

FIG. 19 is a flowchart showing an example of a procedure of the log evacuation processing. First, the log evacuation processing unit 408 of each of the storage controllers 1052A, 1052B, and 1052C refers to the log buffer and reads a non-evacuated log (step S4081). Subsequently, the log evacuation processing unit 408 stores the non-evacuated log in a log area in the non-volatile storage device 1034 (step S4082). A storage position is immediately after a last written log. The log evacuation processing unit 408 deletes the log stored in the log area from the log buffer (step S4084).

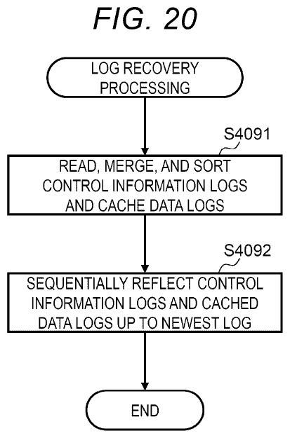

FIG. 20 is a flowchart showing an example of a procedure of log recovery processing. The log recovery processing is called before the storage controllers 1052A, 1052B, and 1052C are started at the time of restart after a power failure. First, the log recovery processing unit 409 of each of the storage controllers 1052A, 1052B, and 1052C sorts control information logs and cache data logs according to the sequence number, and arranges the logs from an oldest log (a log having a smallest sequence number) to a newest log (a log having a largest sequence number) (step S4091).

Thereafter, the log recovery processing unit 409 reflects the logs from the oldest log to the newest log in this order in the storage control information 10321 and the cache data area 10322 in the memory 1032, and the cache data area 10331 in the second volatile storage device 1033, based on log addresses (step S4092). In this way, the log recovery processing unit 409 completes recovery of the control information and the cache data after the power failure.

In the embodiment, in the above-described read processing, even when no cache hit occurs in the cache data area of the memory 1032, the cache hit occurs in the cache data area in the second volatile storage device 1033, and an amount of input from and output to the non-volatile storage device 1034 is reduced. Regarding the dirty data in the cache data area of the memory 1032 generated by the write processing, since the data is stored in the cache data area of the memory and the cache data area in the second volatile storage device 1033 for the predetermined period while remaining in the dirty state, the amount of input from and output to the non-volatile storage device 1034 is reduced by the asynchronous destaging processing.

Accordingly, a performance bottleneck of the amount of input from and output to the non-volatile storage device 1034 can be eliminated to improve performance. Since the second volatile storage device 1033 used in the cloud has higher I/O performance than the non-volatile storage device 1034 and can access the cache area in the second volatile storage device 1033 at high speed, the performance is improved.

The log may be created not only at the time of updating the data related to the write processing but also at the time of updating metadata in a cache associated with a storage function such as a compression function or remote copy.

The storage node 103 of the storage system 100 according to the embodiment includes the memory 1032 as an example of the first volatile storage device that can temporarily store data and stores the data to be transmitted to and received from the request source of the I/O request, the second volatile storage device 1033 that can temporarily store data, the non-volatile storage device 1034 that can permanently store data, and the storage controller that controls the data input and output processing relative to the memory 1032, the second volatile storage device 1033, and the non-volatile storage device 1034. This storage controller moves the data among the memory 1032, the second volatile storage device 1033, and the non-volatile storage device 1034 based on the status of access to the data stored in the memory 1032, the second volatile storage device 1033, and the non-volatile storage device 1034.

In this way, when no cache hit occurs for the data stored in the memory 1032, the data stored in the memory 1032 is moved to and stored in the second volatile storage device 1033 instead of being destaged to the non-volatile storage device 1034, and thus the amount of data input from and output to the non-volatile storage device 1034 can be reduced.

In the embodiment, upon receiving the write request of data from the host apparatus 101 that is an example of the request source, the storage controller stores the data corresponding to the write request in the memory 1032 and stores the log corresponding to the data stored in the memory 1032 in the non-volatile storage device 1034. After storing the log in the non-volatile storage device 1034, the storage controller sends the completion response to the host apparatus 101 and moves the data stored in the memory 1032 to the second volatile storage device 1033 to store the data therein when no cache hit occurs for the data stored in the memory 1032 over the first period from the first time when the data is stored in the memory 1032. Further, the storage controller destages the data stored in the second volatile storage device 1033 to the non-volatile storage device 1034 when no cache hit occurs for the data stored in the second volatile storage device 1033 over the second period from the second time when the data is stored in the second volatile storage device 1033.

In this way, when no cache hit occurs for the data stored in the memory 1032 over the first period, the data stored in the memory 1032 is moved to and stored in the second volatile storage device 1033 instead of being destaged to the non-volatile storage device 1034, and thus the amount of data input from and output to the non-volatile storage device 1034 can be reduced.

In the embodiment, the memory 1032 can input and output data in the data unit related to the I/O request. The second volatile storage device 1033 and the non-volatile storage device 1034 input and output the data in the unit larger than the data unit related to the I/O request.

In the embodiment, for example, the memory 1032 is byte-accessible, and the second volatile storage device 1033 and the non-volatile storage device 1034 are not byte-accessible.

In the embodiment, the storage controller manages the clean data where the data stored in the memory 1032 is identical to the data stored in the non-volatile storage device 1034 and the dirty data where the data stored in the memory 1032 is not destaged to the non-volatile storage device 1034. The storage controller moves the dirty data in the data stored in the memory 1032 to the second volatile storage device 1033 to store the dirty data therein, and does not move the clean data to the second volatile storage device 1033 and does not store the clean data therein. In this way, when no cache hit occurs for the data stored in the memory 1032 over the first period, the data stored in the memory 1032 is moved to and stored in the second volatile storage device 1033 instead of being destaged to the non-volatile storage device 1034, and thus the amount of data input from and output to the non-volatile storage device 1034 can be reduced particularly for the amount of dirty data in the data stored in the memory 1032.

In the embodiment, the storage system 100 includes the plurality of storage nodes 103 each including the memory 1032 that is an example of the first volatile storage device, the second volatile storage device 1033, the non-volatile storage device 1034, and the storage controller. The storage controller in the storage node 103 forms the redundant configuration together with one or more storage controllers on other storage nodes 103. Among the storage controllers forming the redundant configuration, one storage controller 1052A is set to the active state in which the I/O request from the host apparatus 101 that is the request source can be received, and the other storage controller 1052B is set to the standby state for taking over processing of the controller 1052A in the active state. In this way, when no cache hit occurs for the data stored in the memory 1032 over the first period, the storage controller 1052B moves the data stored in the memory 1032 to the second volatile storage device 1033 to store the data therein instead of destaging the data to the non-volatile storage device 1034, and thus the amount of data input from and output to the non-volatile storage device 1034 can be reduced. Meanwhile, the other storage controller 1052A is set to the standby state in which the I/O request from the host apparatus 101 is not received, thereby saving power.

In the embodiment, when the data related to the read request is absent in the memory 1032 and is present in the second volatile storage device 1033, the storage controllers 1052A, 1052B, and 1052C store the data in the second volatile storage device 1033 into the memory 1032 and respond to the host apparatus 101 that is the request source of the read request with the data stored in the memory 1032.

The invention is not limited to the embodiment described above, and includes various modifications and equivalent configurations within the scope of the appended claims. For example, the embodiment described above has been described in detail to facilitate understanding of the invention, and the invention is not limited to those including all the configurations described above. At least one of the elements described as being connected in parallel in the embodiment may be connected in series to another element.

### INDUSTRIAL APPLICABILITY

The invention can be applied to, for example, a storage system related to a technique using a cache when reading and writing data from and to a host apparatus.

What is claimed is:

1. A storage system comprising:
a first volatile storage device configured to temporarily store data and store data to be transmitted to and received from a request source of an I/O request;
a second volatile storage device configured to temporarily store data;
a non-volatile storage device configured to permanently store data; and
a storage controller configured to control input and output processing of data from and to the first volatile storage device, the second volatile storage device, and the non-volatile storage device, wherein
based on a status of access to data stored in the first volatile storage device, the second volatile storage device, and the non-volatile storage device, the storage controller moves the data among the first volatile storage device, the second volatile storage device, and the non-volatile storage device.

2. The storage system according to claim 1, wherein
the storage controller
stores, upon receiving a write request of data from the request source, the data corresponding to the write request in the first volatile storage device,
stores, in the non-volatile storage device, a log corresponding to the data stored in the first volatile storage device, and
sends a completion response to the request source after storing the log in the non-volatile storage device.

3. The storage system according to claim 1, wherein
when no cache hit occurs for the data stored in the first volatile storage device over a first period from a first time when the data is stored in the first volatile storage device, the storage controller moves the data stored in the first volatile storage device to the second volatile storage device to store the data therein.

4. The storage system according to claim 3, wherein
when no cache hit occurs for the data stored in the second volatile storage device over a second period from a second time when the data is stored in the second volatile storage device, the storage controller destages the data stored in the second volatile storage device to the non-volatile storage device.

5. The storage system according to claim 1, wherein
the first volatile storage device is configured to input and output data in a data unit related to the I/O request, and
the second volatile storage device and the non-volatile storage device input and output data in a unit larger than the data unit related to the I/O request.

6. The storage system according to claim 1, wherein
the first volatile storage device is byte-accessible, and
the second volatile storage device and the non-volatile storage device are not byte-accessible.

7. The storage system according to claim 1, wherein
the second volatile storage device includes an instance store.

8. The storage system according to claim 1, wherein
the storage controller
manages clean data where the data stored in the first volatile storage device is identical to the data stored in the non-volatile storage device, and dirty data where the data stored in the first volatile storage device is not identical to the data stored in the non-volatile storage device, and
moves the dirty data in the data stored in the first volatile storage device to the second volatile storage device to store the dirty data therein, and does not move the clean data to the second volatile storage device and does not store the clean data therein.

9. The storage system according to claim 1, further comprising:
a plurality of storage nodes each including the first volatile storage device, the second volatile storage device, the non-volatile storage device, and the storage controller, wherein
the storage controller in each of the storage nodes forms a redundant configuration together with one or more storage controllers on other storage nodes,
among the storage controllers forming the redundant configuration, one of the storage controllers is set to an active state in which the I/O request from the request source is receivable, and
the storage controller other than the storage controller in the active state is set to a standby state for taking over processing from the controller in the active state.

10. The storage system according to claim 1, wherein
when data related to a read request is absent in the first volatile storage device and is present in the second volatile storage device, the storage controller stores the data in the second volatile storage device into the first volatile storage device and responds to a request source of the read request with the data stored in the first volatile storage device.

11. A storage control method for a storage system, wherein
the storage system includes
a first volatile storage device configured to temporarily store data and store data to be transmitted to and received from a request source of an I/O request,
a second volatile storage device configured to temporarily store data,
a non-volatile storage device configured to permanently store data, and
a storage controller configured to control input and output processing of data from and to the first volatile storage device, the second volatile storage device, and the non-volatile storage device, and
based on a status of access to data stored in the first volatile storage device, the second volatile storage device, and the non-volatile storage device, the storage controller moves the data among the first volatile storage device, the second volatile storage device, and the non-volatile storage device.
